(19) United States
(12) Patent Application Publication
(10) Pub. No.: US 2011/0304797 A1
(43) Pub. Date: Dec. 15, 2011

(54) LIQUID CRYSTAL DISPLAY DEVICE

(76) Inventors: Mitsuhiro Murata, Osaka (JP); Shoichi Ishihara, Osaka (JP); Shuichi Kozaki, Osaka (JP); Takehisa Sakurai, Osaka (JP); Masako Nakamura, Osaka (JP); Tadashi Ohtake, Osaka (JP)

(21) Appl. No.: 13/202,664

(22) PCT Filed: Mar. 8, 2010
(86) PCT No.: PCT/JP2010/053807

§ 371 Date: Aug. 22, 2011

(30) Foreign Application Priority Data
May 29, 2009 (JP) 2009-130187
Jan. 13, 2010 (JP) 2010-005108

(51) Int. Cl. G02F 1/1335

(52) U.S. Cl. 349/62

(57) ABSTRACT

The present invention provides a liquid crystal display device that suppress moiré generated when a voltage is applied in a liquid crystal mode that drives a vertical alignment liquid crystal by using at least a pair of comb-shaped electrodes. A liquid crystal display device of the present invention comprises: a liquid crystal display panel including a liquid crystal layer and a pair of substrates sandwiching the liquid crystal layer; and a backlight unit disposed on a back side of the liquid crystal display panel, one of the pair of substrates including a pair of comb-shaped electrodes each having comb teeth, the comb teeth of one of the pair of comb-shaped electrodes and the comb teeth of the other of the pair of comb-shaped electrodes being disposed alternately and spaced apart from each other, the liquid crystal layer containing liquid crystal molecules with positive dielectric anisotropy, the liquid crystal molecules being aligned in a direction perpendicular to a surface of one of the pair of substrates when no voltage is applied, the backlight unit having an optical sheet with multiple folds parallel to one another on a surface, the pitch width of the pair of comb-shaped electrodes being different from an integral multiple of the pitch width of the folds of the optical sheet.

### TECHNICAL FIELD

The present invention relates to a liquid crystal display device. More particularly, the present invention relates to a liquid crystal display device with a display mode for imparting vertical alignment as the initial alignment to liquid crystal molecules, and controlling the liquid crystal molecules by an electric field (for example, a transverse electric field) generated.

### BACKGROUND ART

Liquid crystal display devices have been widely used in various fields because of its characteristics such as thinness, light weight, and low power consumption. Liquid crystal display devices are generally provided with backlight units for display. Sunlight may be used as light sources for display by reflecting the sunlight. However, liquid crystal display devices which are mainly used indoors such as word processors, laptop personal computers, and on-vehicle display devices, and liquid crystal display devices which are used outdoors and constantly needing a certain brightness require backlight units including light sources.

Edge light backlight units and direct backlight units are generally known as backlight units. Liquid crystal display devices including small screens can perform display with low power consumption because of their small number of light sources. Therefore, edge light backlight units suitable for realizing thin-profile devices are commonly used in such liquid crystal display devices.

Examples of members of backlight units include, in addition to light sources, reflective sheets, diffusion sheets, prism sheets, and light guide plates. In the edge light backlight units, light emitted from the light sources enters the light guide plates from the side faces of the light guide plates, and is reflected and diffused. The resulting light is then emitted as planar light from main faces of the light guide plates. The light further passes through prism sheets, and goes out as display light from the backlight units.

However, in the case where a large number of pixel portions forming a display pixel of a liquid crystal display panel are arranged in a matrix pattern, and the alignment pitch of the pixel portions and the alignment pitch of a prism sheet of a backlight unit are close to each other, light interference may cause fringes (moiré). In order to solve this problem, Patent Document 1, for example, examines improved techniques of suppressing moiré by tilting the extending direction of a prism array of the prism sheet at a predetermined angle to the direction of a pixel portion array, and adjusting the angle formed by the direction of the optical axis of the prism sheet and the length direction of the incidence face of a light guide structure and the angle formed by the direction of the transmission axis of a polarizing plate of a liquid crystal display element and the length direction of the incidence face of the light guide structure so as to satisfy a predetermined relationship between these two angles.

Patent Document 2, for example, discloses improved techniques of suppressing moiré by a diffraction grating. Specifically, in order to obscure a matrix-like pixel pattern and the same color dot cycle in a liquid crystal display element with multiple pixels arranged therein, the diffraction grating and a birefringent plate are disposed on an observation face side of a liquid crystal display element to perform a pixel diffusion with a large shift amount by the diffraction grating.

However, the means disclosed in Patent Document 1 still has room for improvement in that the direction of the polarization axis of the polarizing plate of the liquid crystal display panel is strictly limited, and luminance tends to fall in the liquid crystal display panel in which the polarization axis is tilted at an angle of from 0° to 180° or from 90° to 270° to the length direction of the backlight. Further, the means disclosed in Patent Documents 2 has room for improvement in that character blurring or character bleeding may occur because display is likely to be affected by ambient light.

### [Patent Document 1]

Japanese Kokai Publication No. 2008-139819

### [Patent Document 2]

Japanese Kokai Publication No. Hei-9-325204

### DISCLOSURE OF THE INVENTION

Display modes of liquid crystal display devices are classified according to methods for aligning liquid crystal. Examples of conventionally known display modes of liquid crystal display devices include a TN (Twisted Nematic) mode, a VA (Vertical Alignment) mode, an IPS (In-Plane Switching) mode, and an OCB (Optically self-Compensated Birefringence) mode.

Alternately, a display mode has been recently proposed in which nematic liquid crystal with positive dielectric anisotropy is used as a liquid crystal material, the nematic liquid crystal is vertically aligned to provide and maintain high contrast, and in addition, a transverse electric field is generated using a pair of comb-shaped electrodes to control alignment of liquid crystal molecules. How the present invention is completed will be described with reference to the above-mentioned mode. The present invention is not limited to such a mode.

In the mode, directors (liquid crystal molecules) are aligned along a transverse electric field generated in an arch shape between a pair of comb-shaped electrodes arranged on one and the same substrate. According to this, directors forms an arch-shaped distribution having symmetry along a transverse electric field, and the directors form alignment similar to bend alignment in a transverse direction. As a result, even if a display face is observed in an oblique direction, the same display quality as that observed in a front direction can be visually recognized. Therefore, as in a VA mode, for example, the problem will be solved in that rod-shaped liquid crystal molecules cause different states of optical birefringence between the front direction and the oblique direction and change voltage-transmission characteristics (V-T characteristics) depending on the viewing angle.

However, in the mode, when a voltage is applied to a liquid crystal layer, that is, during white display, interference fringes (moiré) may occur on a display screen.

The present invention has been made in view of the above-mentioned state of the art. It is an object of the present invention to provide a liquid crystal display device that suppress moiré generated when a voltage is applied in a liquid crystal mode that drives a vertical alignment liquid crystal by using at least a pair of comb-shaped electrodes.

The present inventors made various investigations on the reason why interference fringes occur in the mode. They noted that although almost all directors shift from perpendicular alignment (black display) to bend alignment (white display) when a voltage is applied, in principle, directors just above an electrode remain aligned perpendicularly, and display by the electrode remains black. They further noted the configuration of a backlight unit, and fount that in the case where the surface of a lens sheet of the backlight unit has a periodic recessed and projecting pattern, light interference occurs because of a periodic shape of the lines of the recessed and projecting pattern and a periodic shape of lines of comb teeth of a comb-shaped electrode, which causes generation of interference fringes on a display screen.

As a means for suppressing generation of interference fringes, for example, the lens sheet can be rotated so that the lines of the recessed and projecting pattern have an angle to the lines of the comb teeth. However, in this case, light from a light source is not sufficiently used effectively, and luminance may be deteriorated.

As a result of further earnest investigations made by the present inventors, they found that the period of the lines of the recessed and projecting pattern of the lens sheet and the period of the lines of the comb teeth are shifted, whereby generation of moiré can be avoided without rotation of the lens sheet. Specifically, they found that the pitch width of the lines of the comb teeth is adjusted to be different from an integral multiple of the pitch width of the recessed and projecting lines of the lens sheet, whereby generation of moiré can be sufficiently suppressed. As a result, the above-mentioned problems have been admirably solved, leading to completion of the present invention.

### DISCLOSURE OF THE INVENTION

That is, the present invention is a liquid crystal display device, comprising:

a liquid crystal display panel including a liquid crystal layer and a pair of substrates sandwiching the liquid crystal layer; and

a backlight unit disposed on a back side of the liquid crystal display panel,

one of the pair of substrates including a pair of comb-shaped electrodes each having comb teeth, the comb teeth of one of the pair of comb-shaped electrodes and the comb teeth of the other of the pair of comb-shaped electrodes being disposed alternately and spaced apart from each other,

the liquid crystal layer containing liquid crystal molecules with positive dielectric anisotropy,

the liquid crystal molecules being aligned in a direction perpendicular to a surface of the one of the pair of substrates when no voltage is applied,

the backlight unit having an optical sheet with multiple folds parallel to one another on a surface,

the pitch width of the pair of comb-shaped electrodes being different from an integral multiple of the pitch width of the folds of the optical sheet.

The liquid crystal display device of the present invention includes a liquid crystal display panel including a liquid crystal layer and a pair of substrates sandwiching the liquid crystal layer, and a backlight unit disposed on a back side of the liquid crystal display panel. The liquid crystal layer is filled with liquid crystal molecules whose alignment is controlled by applying a certain voltage. The pair of substrates is provided with lines, electrodes, semiconductor devices, and the like. With such substrates, a voltage is applied to the liquid crystal layer, which controls alignment of the liquid crystal molecules. The backlight unit includes a light source, and is provided with optical members such as a lens sheet, a diffusion sheet, a reflective sheet, and a light guide plate. The backlight unit is disposed on a back face side of the liquid crystal display panel and emits light to the observation face side.

The one of the pair of substrates includes a pair of comb-shaped electrodes each having comb teeth. The comb teeth of one of the pair of comb-shaped electrodes and the comb teeth of the other of the pair of comb-shaped electrodes are disposed alternately and spaced apart from each other. The term “comb-shaped” as used herein refers to a shape basically composed of a handle portion as a trunk and a comb-teeth portion protruded from the handle portion. An electric field is, for example, an arch-shaped transverse electric field when a potential difference is given between the pair of comb-shaped electrodes. The liquid crystal molecules are aligned according to the direction of such an electric field, and therefore display in a front direction and display in an oblique direction, relative to a substrate surface, are the same as each other.

The liquid crystal layer includes liquid crystal molecules with positive dielectric anisotropy. Such liquid crystal molecules are aligned in the same direction as that of the electric field by applying a voltage to the liquid crystal layer. As a result, for example, the liquid crystal molecules show alignment similar to transverse bend alignment.

The liquid crystal molecules are aligned in a direction perpendicular to a surface of the one of the pair of substrates in a state where no voltage is applied (hereinafter referred to simply as “vertical alignment”). Thus, the initial alignment of the liquid crystal molecules is adjusted, which efficiently blocks light for performing black display. In order to vertically align the liquid crystal molecules in a state where no voltage is applied, a vertical alignment film is disposed on a surface, which is in contact with the liquid crystal layer, of one or both of the pair of substrates. Here, if one line is perpendicular to another line, they form an angle of 90±4°. If the angle is less than 86° or exceeds 94°, contrast decreases.

Accordingly, according to the liquid crystal display device of the present invention, the liquid crystal molecules are vertically aligned in a state where no voltage is applied, which achieves high contrast. Further, the liquid crystal molecules are transversely aligned to form alignment similar to bend alignment in a state where a voltage is applied, which achieves a wider viewing angle.

The backlight unit has an optical sheet which has multiple folds parallel to one another on a surface. Examples of the optical sheet that can have such a structure include a lens sheet that condenses light, and a light guide plate that guides light in a direction of the display surface. The optical sheet having the folds have such a pattern on at least a surface, and the entire optical sheet may have such a pattern along the folds.

The pitch width of the comb teeth of the pair of comb-shaped electrodes is different from an integral multiple of the pitch width of the folds of the optical sheet. The “pitch width” used herein is a concept to specify a periodic width in a periodic structure having multiple lines, and is defined by the distance between center lines of each line. Further, this pitch width is also defined in the same way even in the total length of one line width and one space width in a periodic structure having lines with a constant width and spaces (distance) with a constant width.

For example, the pitch width between two members, such as the pitch width of the comb teeth of a pair of comb-shaped electrodes, means the length between lines of each of the two members, that is, the length between the center line of the comb tooth line of one comb-shaped electrode and the center line of the comb tooth line of the other comb-shaped electrode. In the case where the pitch width of the pair of comb-shaped electrodes is specified with one line width and one space width, the one line width means the size of the comb tooth in the width direction that is orthogonal to the length direction of the comb teeth of one comb-shaped electrode or the comb teeth of the other comb-shaped electrode. In addition, the one space width means the size of the comb tooth in the width direction that is orthogonal to the length direction of the comb teeth in the space between the comb teeth of one comb-shaped electrode and the comb teeth of the other comb-shaped electrode. The total width of the one line width and the one space width corresponds to the pitch width of a pair of comb-shaped electrodes.

Meanwhile, the pitch width in one member, such as the pitch width of folds of an optical sheet, refers to the length between the center lines of the line of the member, that is, the length between the center lines of the fold.

In the present invention, the pitch width of the comb teeth of a pair of comb-shaped electrodes is different from an integral multiple of the pitch width of the folds of the optical sheet. Therefore, canceling due to interference occurs in light that consecutively transmits through both the pair of comb-shaped electrodes and the optical sheet, and interference fringes in which a black display portion and a white display portion appear periodically can be prevented. Specifically, the expression “different from an integral multiple” used herein means that a ratio of a larger pitch width to a smaller pitch width out of the pitch width of the comb teeth of the pair of comb-shaped electrodes and the pitch width of the folds of the optical sheet, that is, a value represented by “a larger pitch width/a smaller pitch width” is not an integer. The term “integral multiple” used herein includes an error range of less than 0.1 times. For example, the integral multiple does not include 1.2 times, but includes 1.02 times or 0.98 times.

The configuration of the liquid crystal display device according to the present invention is not especially limited as long as the above-mentioned components are essentially comprised. The liquid crystal display device may or may not comprise other components.

Preferable embodiments of the liquid crystal display device of the present invention will be described in detail.

It is preferable that comb tooth lines of the comb-shaped electrodes are each parallel to the folds of the optical sheet. The higher the angle formed by comb tooth lines of the comb-shaped electrodes and a fold of the optical sheet is, the worse the light use efficiency is, and the worse the luminance of the entire display is. Therefore, according to the present embodiment, moiré interference can be prevented while high luminance is maintained. The term “parallel” used herein refers to the range of from 0° to 3.0°.

It is preferable that the pitch width of the comb teeth of the pair of comb-shaped electrodes is 9.5 μm or less. If the pitch width of the pair of comb-shaped electrodes exceeds 9.5 μm, the larger the pitch width is, the more likely generation of moiré is to be visually observed. The pitch width of the pair of comb-shaped electrodes in the above range of this embodiment can give better effects of suppressing moiré.

It is preferable that the pitch width of the comb teeth of the pair of comb-shaped electrodes is 9.5 to 12.5 μm, and the angle formed by a comb tooth line of the comb-shaped electrodes and a fold of the optical sheet is lower than 3°. The larger the angle formed by the comb tooth line of the comb-shaped electrodes and the fold of the optical sheet is, the less likely moiré is to be generated. An angle of lower than 3° is an allowable range because the luminance does not significantly decrease. Meanwhile, if the angle formed by the comb tooth line of the comb-shaped electrodes and the fold of the optical sheet is 3° or higher, the luminance significantly decreases. Accordingly, the above allowable range with a good balance between the reduction in luminance and generation of moiré enables good display.

It is preferable that the pitch width of the comb teeth of the pair of comb-shaped electrodes is 7.5 μm or higher. The pitch width of the pair of comb-shaped electrodes of less than 7.5 μm is not problematic in terms of suppression of moiré, but a pitch width of 7.5 μm or higher is preferable in terms of the transmittance.

### EFFECT OF THE INVENTION

The present invention provides a liquid crystal display device that suppress moiré interference generated by comb-shaped electrodes of a liquid crystal display panel and an optical sheet of a backlight unit when a voltage is applied in a vertical alignment type liquid crystal mode.

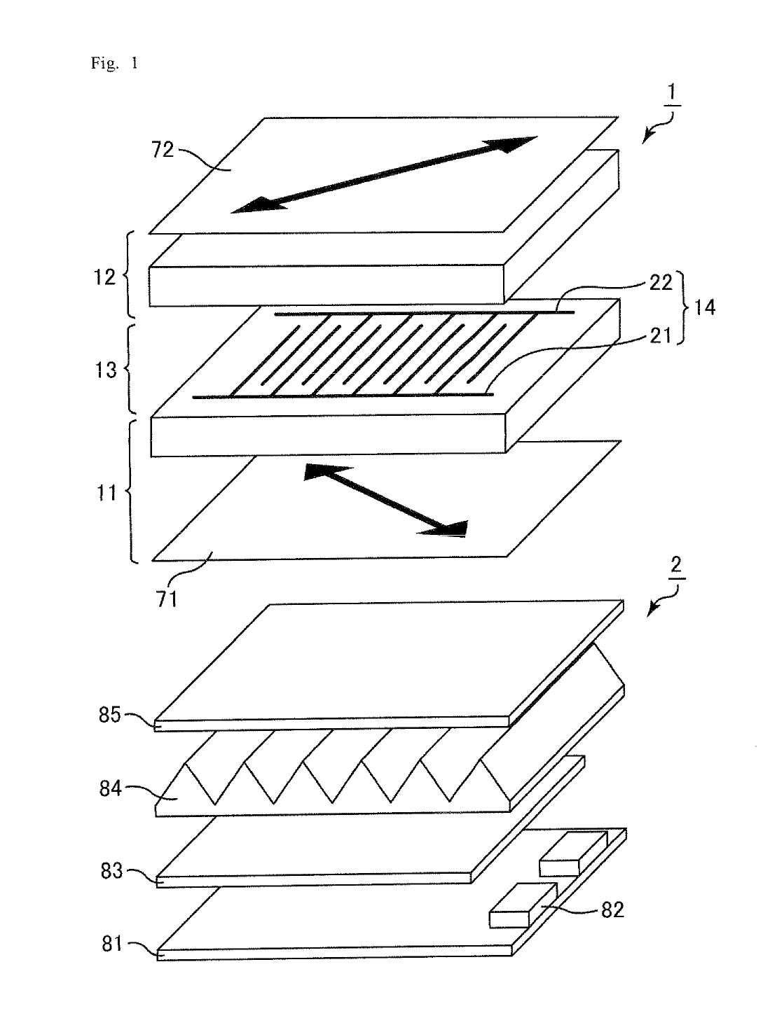

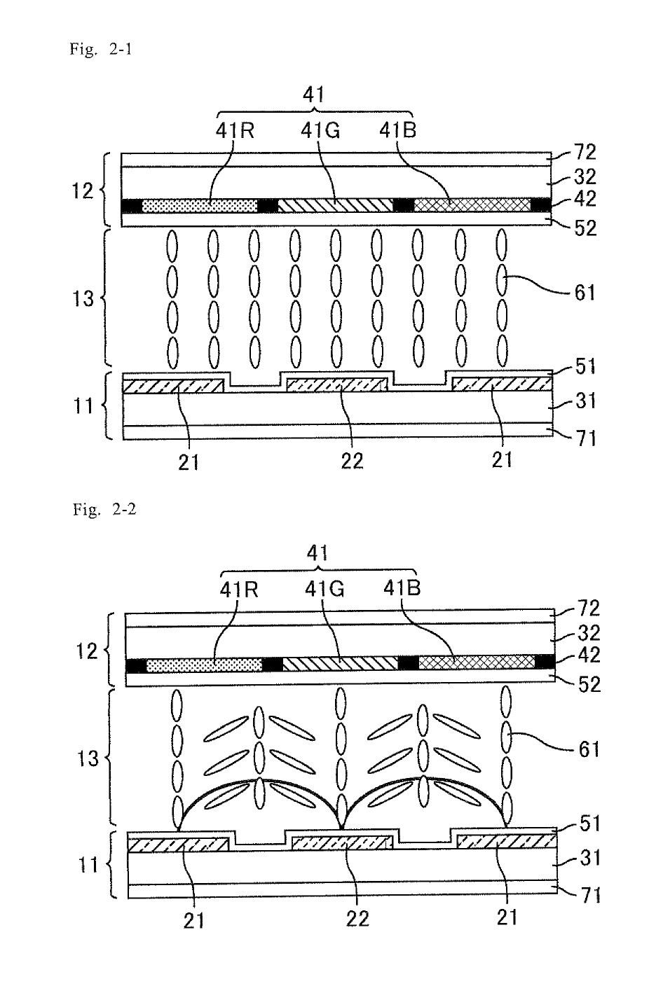

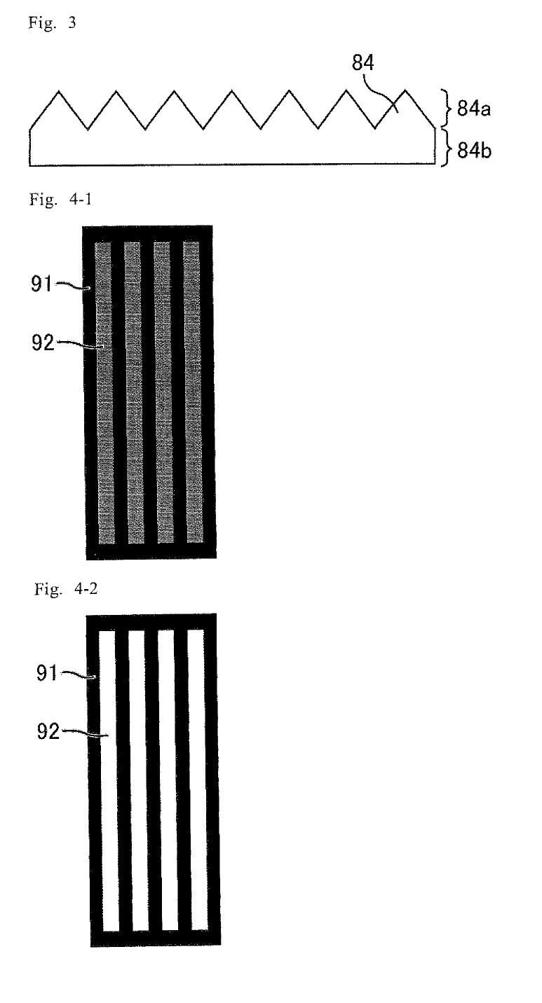

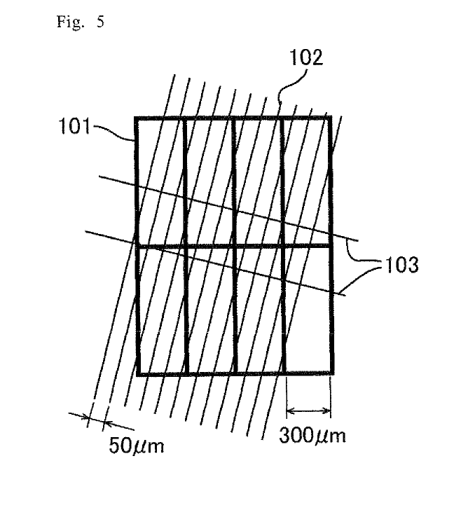

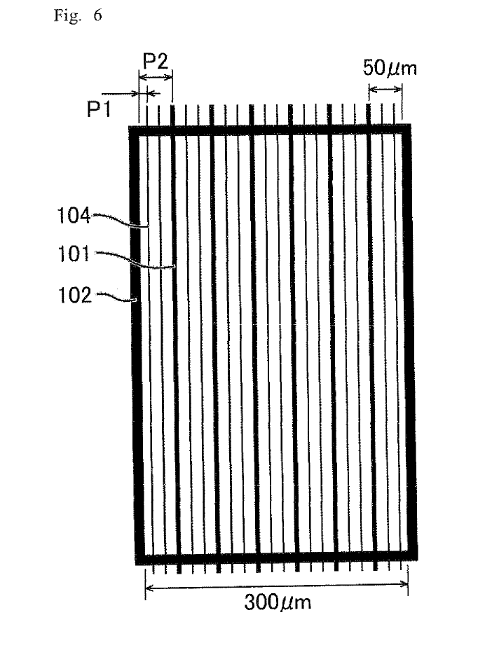

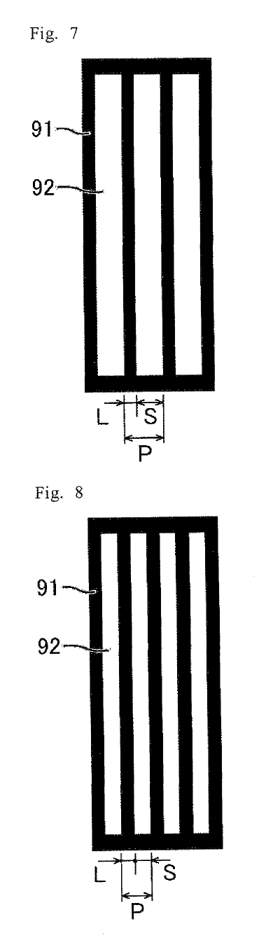

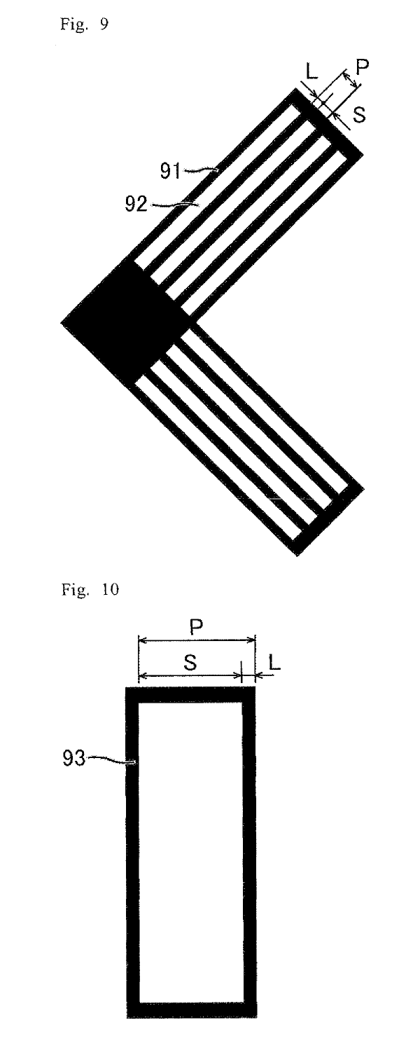

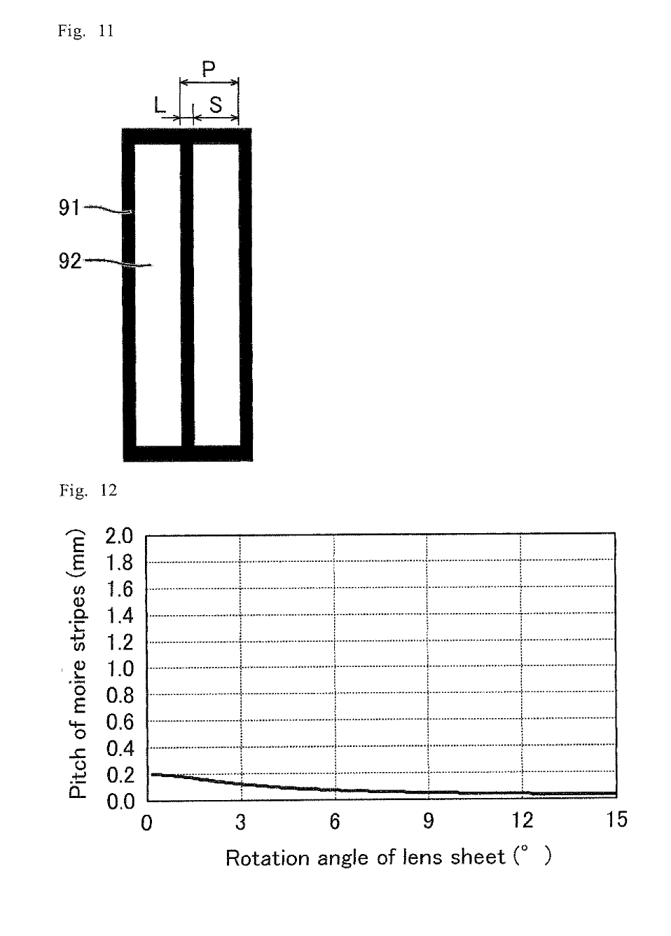

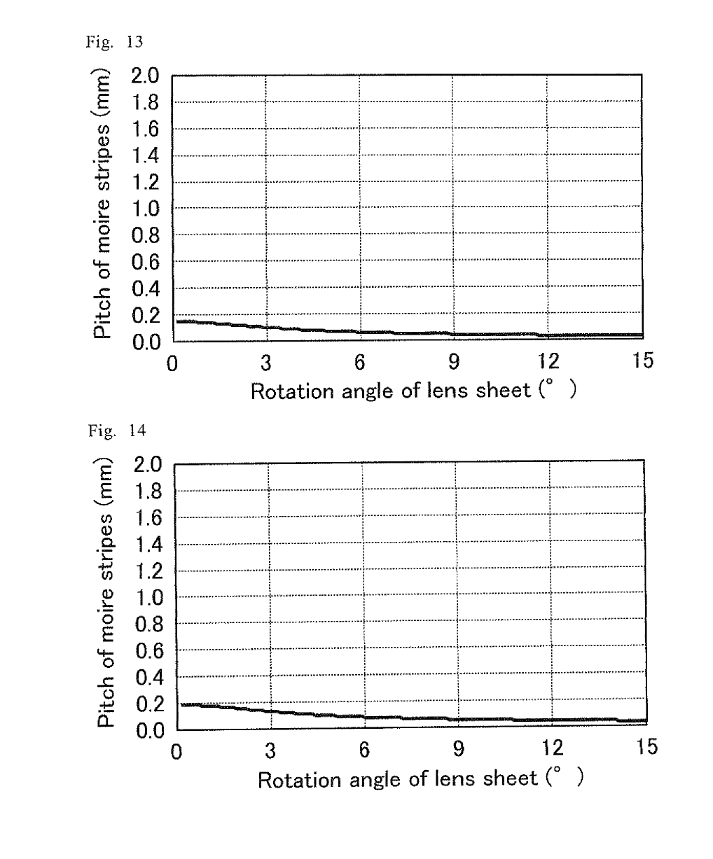

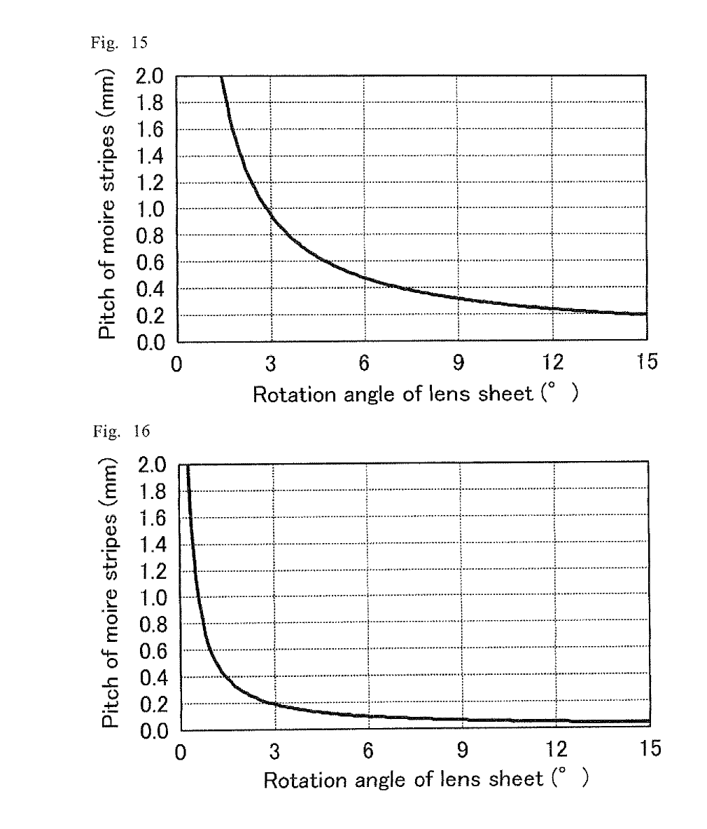

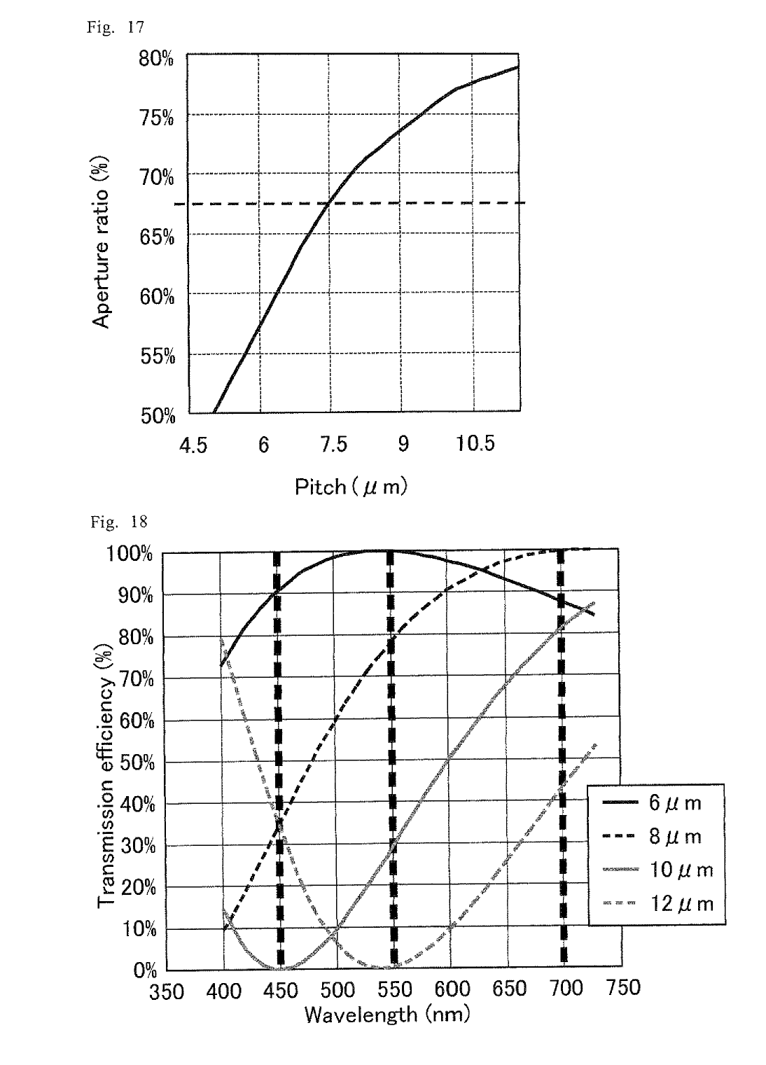

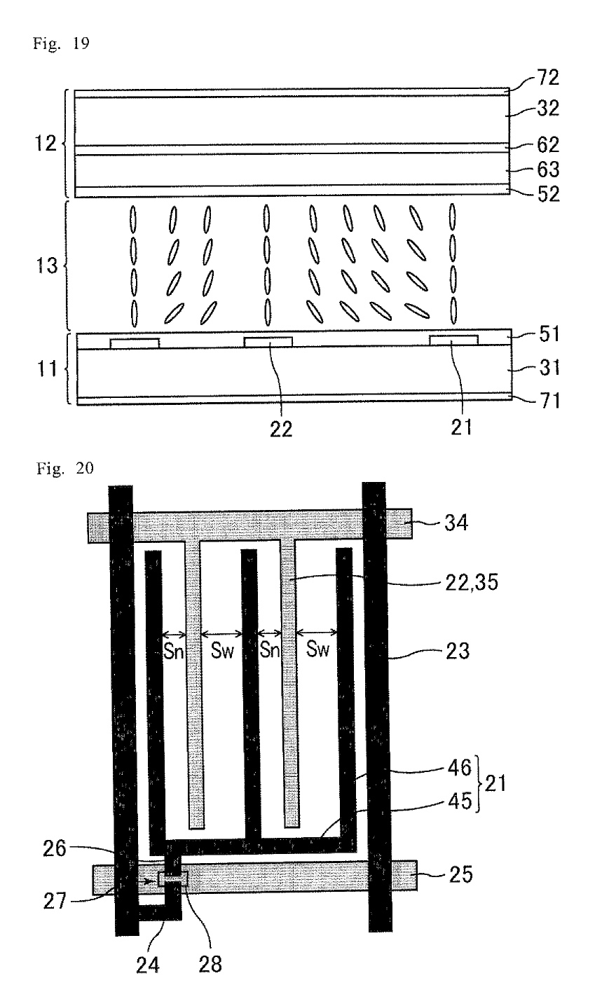

### BRIEF DESCRIPTION OF THE DRAWINGS

[FIG. 1] FIG. 1 is a perspective view schematically showing a liquid crystal display device in accordance with Embodiment 1.

[FIG. 2-1] FIG. 2-1 is a cross-sectional view schematically showing the liquid crystal display device in accordance with Embodiment 1, where no voltage is applied to a liquid crystal layer.

[FIG. 2-2] FIG. 2-2 is a cross-sectional view schematically showing the liquid crystal display device in accordance with Embodiment 1, where a voltage is applied to a liquid crystal layer.

[FIG. 3] FIG. 3 is a cross-sectional view schematically showing a lens sheet usable in Embodiment 1.

[FIG. 4-1] FIG. 4-1 is a plan view schematically showing a sub pixel unit in a display region of the liquid crystal display device of Embodiment 1 when no voltage is applied.

[FIG. 4-2] FIG. 4-2 is a plan view schematically showing a sub pixel unit in a display region of the liquid crystal display device of Embodiment 1 when a voltage is applied.

[FIG. 5] FIG. 5 is a first conceptual view showing generation of moiré.

[FIG. 6] FIG. 6 is a second conceptual view showing generation of moiré.

[FIG. 7] FIG. 7 is a plan view schematically showing a sub pixel unit in a display region of a liquid crystal display device of Example 1.

[FIG. 8] FIG. 8 is a plan view schematically showing a sub pixel unit in a display region of a liquid crystal display device of Example 2.

[FIG. 9] FIG. 9 is a plan view schematically showing a sub pixel unit in a display region of a liquid crystal display device of Example 3.

[FIG. 10] FIG. 10 is a plan view schematically showing a sub pixel unit in a display region of a liquid crystal display device of Comparative Example 1.

[FIG. 11] FIG. 11 is a plan view schematically showing a sub pixel unit in a display region of a liquid crystal display device of Comparative Example 2.

[FIG. 12] FIG. 12 is a graph showing the relationship between a pitch (mm) of moiré stripes generated upon displaying with the liquid crystal display device of Example 1 and a rotation angle of a BEF lens (°).

[FIG. 13] FIG. 13 is a graph showing the relationship between a pitch (mm) of moiré stripes generated upon displaying with the liquid crystal display device of Example 2 and a rotation angle of a BEF lens (°).

[FIG. 14] FIG. 14 is a graph showing the relationship between a pitch (mm) of moiré stripes generated upon displaying with the liquid crystal display device of Example 3 and a rotation angle of a BEF lens (°).

[FIG. 15] FIG. 15 is a graph showing the relationship between a pitch (mm) of moiré stripes generated upon displaying with the liquid crystal display device of Comparative Example 1 and a rotation angle of a BEF lens (°).

[FIG. 16] FIG. 16 is a graph showing the relationship between a pitch (mm) of moiré stripes generated upon displaying with the liquid crystal display device of Comparative Example 2 and a rotation angle of a BEF lens (°).

[FIG. 17] FIG. 17 is a graph showing the relationship between a pitch width of comb teeth of a pair of comb-shaped electrodes and an aperture ratio.

[FIG. 18] FIG. 18 is a graph that summarizes transmission efficiency of multiple diffraction pitches for every wavelength calculated by the general formula of diffraction efficiency at the time of the transmission when Δn=0.0505.

[FIG. 19] FIG. 19 is a cross-sectional view schematically showing a configuration of a liquid crystal display device in accordance with Embodiment 2.

[FIG. 20] FIG. 20 is a plan view schematically showing the configuration of the liquid crystal display device in accordance with Embodiment 2.

### MODES FOR CARRYING OUT THE INVENTION

The present invention will be mentioned in more detail referring to the drawings in the following embodiments, but is not limited to these embodiments.

### Embodiment 1

FIG. 1 is a perspective view schematically showing a liquid crystal display device in accordance with Embodiment 1. The liquid crystal display device of Embodiment 1 includes a liquid crystal display panel 1 having a liquid crystal layer 13 and a pair of substrates 11 and 12 sandwiching the liquid crystal layer 13. Specifically, the TFT substrate 11, the liquid crystal layer 13, and the counter substrate 12 are disposed in this order from a back face side toward a observation face side of the liquid crystal display device of Embodiment 1. The liquid crystal layer 13 includes nematic liquid crystal with positive dielectric anisotropy (Δε>0). The liquid crystal display device of Embodiment 1 includes a backlight unit 2 disposed on the back face side of the liquid crystal display panel 1.

As shown in FIG. 1, the TFT substrate 11 of the pair of substrates has a pair of comb-shaped electrodes 14 in which comb teeth of one of the pair of comb-shaped electrodes and comb teeth of the other of the pair of comb-shaped electrodes 14 are alternately disposed and spaced apart from each other. The one of the pair of comb-shaped electrodes 14 is a pixel electrode 21 to which a signal voltage is applied through signal lines (source lines), and the other is a counter electrode 22 to which a common voltage is applied through common lines. Each of the pixel electrode 21 and the counter electrode 22 includes a handle portion as a trunk and comb teeth protruded from the handle portion as essential components. Preferred examples of the materials used in the pixel electrode 21 and the counter electrode 22 include metal oxides such as indium tin oxide (ITO) with translucency.

The pixel electrode 21 is connected with a thin film transistor (TFT) including a semiconductor layer, and further connected with a source line via the TFT. The TFT is connected with a gate line, and a gate voltage is applied to the semiconductor layer via the gate line. At the same time, the source line and the pixel electrode 21 are electrically connected with each other, and the signal voltage is applied to the pixel electrode 21.

The counter electrode 22 is connected with the common line that is located at an area overlapping with the gate line and source line. An insulating film is disposed between the common line, and the gate line and source line. The gate line and the source line are arranged perpendicular to each other. A region surrounded with two gate lines and two source lines, that is, a region surrounded with the common lines forms one sub pixel. One color filter is arranged to correspond one sub pixel, and a plurality of sub pixels form one pixel.

FIGS. 2-1 and 2-2 are cross-sectional views schematically showing the liquid crystal display device in accordance with Embodiment 1, and particularly showing behavior of liquid crystal molecules in detail. FIG. 2-1 shows a state of a liquid crystal layer to which no voltage is applied. FIG. 2-2 shows a state of a liquid crystal layer to which a voltage is applied.

The TFT substrate 11 has a glass substrate 31, and the pixel electrode 21 and the counter electrode 22 disposed on the liquid-crystal-layer-13-side surface of the glass substrate 31. The pixel electrode 21 and the counter electrode 22 are alternately arranged in a transverse direction when viewed in a cross section.

The counter substrate 12 includes a glass substrate 32 and a color filter 41. The color filter 41 is arranged on the liquid-crystal-layer-13-side surface of the glass substrate 32. The color filter 41 is composed of at least one of a red color filter 41R, a green color filter 41G, and a blue color filter 41B. One color filter corresponds to one sub pixel. Combination of red, green, and blue sub pixels forms one pixel. The color filter 41 may include colors other than these colors. A black-colored black matrix (BM) 42 is arranged between the adjacent two color filters having colors different from each other to prevent color mixing and light leakage.

Vertical alignment films 51 and 52 are arranged on surfaces of the TFT substrate 11 and the counter substrate 12, respectively. The surfaces are in contact with the liquid crystal layer 13. As shown in FIG. 2-1, liquid crystal molecules 61 have homeotropic alignment, that is, alignment perpendicular to the surfaces of the pair of substrates 11 and 12, when no voltage is applied. Specifically, longitudinal axes of the rod-shaped liquid crystal molecules 61 are oriented in a direction perpendicular to the substrate surface. The molecules 61 are oriented in the same direction and regularly arranged.

As shown in FIG. 2-2, when a voltage is applied between the pixel electrode 21 and the counter electrode 22, the liquid crystal molecules 61 are aligned along an arch-shaped transverse electric field formed between the electrodes. The liquid crystal molecules 61 are thus influenced by such an electric field, and transversely aligned as a whole to form bend alignment in which the molecules are aligned symmetrically to a middle region between the comb teeth (the pixel electrode 21 and the counter electrode 22). However, as shown in FIG. 2-2, liquid crystal molecules 61 present at an end of the arch-shaped transverse electric field, that is, liquid crystal molecules 61 present at just above the pixel electrode and the counter electrode 22 are less likely to be affected by the electric field change of the liquid crystal molecules 61. Therefore, such liquid crystal molecules 61 remain aligned in a direction perpendicular to the substrate surface. The middle region is a region farthest from the comb teeth. Therefore, liquid crystal molecules 61 present at the middle region between the comb teeth (the pixel electrode 21 and the counter electrode 22) also remain aligned in a direction perpendicular to the pair of substrates 11 and 12.

The TFT substrate 11 and the counter substrate 12 have polarizers 71 and 72, respectively. The polarizer 71 is arranged in the outermost portion of the back face side of the TFT substrate 11. The polarizer 72 is arranged in the outermost portion of the observation face side of the counter substrate 12. The polarizers 71 and 72 are allowed to convert natural light emitted from a light source into polarized light vibrating in a certain direction (a polarization axis direction). The arrows in the polarizers 71 and 72 shown in FIG. 1 show the respective polarized light axis directions of the polarizers.

According to Embodiment 1, the liquid crystal molecules 61 are aligned in a direction perpendicular to the substrates 11 and 12 when no voltage is applied. Therefore, the transmission axis of the polarizer 71 of the TFT substrate 11 intersects with the transmission axis of the polarizer 72 of the counter substrate 12 (they are in a cross-Nicol state). Accordingly, light transmitting through the liquid crystal layer 13 when no voltage is applied is blocked with the polarizers 71 and 72. As mentioned above, the liquid crystal molecules 61 have a vertical alignment as the initial alignment, and the polarizers 71 and 72 are in a cross-Nicol state, which provide a normally black display mode with a high contrast ratio.

Meanwhile, in the case where a voltage is applied, the liquid crystal molecules 61 are aligned along a transverse electric field, and at this time a vibrating direction (polarized light axis) of light transmitted through the liquid crystal layer 12 is changed. So, the light transmitted through the liquid crystal layer 12 can pass through the polarizer 72 on the counter substrate 12 side. As a result, the light passes through the liquid crystal display panel 1 and is used as display light.

The configuration of the backlight unit 2 in Embodiment 1 is described in detail below. The backlight unit 2 includes a reflective sheet 81, a light source 82, a light guide plate 83, a lens sheet 84, and a diffusion sheet 85. Among such members, the reflective sheet 81 is arranged in the outermost portion of the back face side, and the light guide plate 83 is arranged on the reflective sheet 81 (observation face side of the reflective sheet). The light source 82 is arranged beside the light guide plate 83, and the lens sheet 84 is arranged on the light guide plate 83. The light source 82 emits light to the light guide plate 83. Further, the diffusion sheet 85 is disposed on the lens sheet 84.

The reflective sheet 81 is a member arranged for improvement of utilization efficiency of light emitted from the light source 82, and covers the entire bottom face of the backlight unit 2. Examples of a material of the reflective sheet 81 include polyethylene terephthalate (PET), a multilayer structure of a polyester resin, and a mixture of a polyester resin and an urethane resin.

The light source 82 is a member which emits light used for display in the liquid crystal display device. Examples of the light source 82 include a cold cathode fluorescent tube (CCFT), a light-emitting diode (LED), and an organic electro-luminescence (OEL). When used as the light source 82, the multiple LEDs are arranged along a side face of the light guide plate.

The light guide plate 83 is a transparent and colorless plate which guides light entering the light guide plate 83 to a display face. In Embodiment 1, light emitted from the light source 82 once enters the light guide plate 83 from the side face thereof, and the incident light is reflected, refracted, and diffused with a structure pattern formed in the light guide plate 83, and emitted as planar light from a main face side of the light guide plate 83 toward the liquid crystal display panel 1.

The lens sheet (prism sheet) 84 is an optical sheet that condenses diffused light emitted from the light guide plate 83 in a front direction and increases the luminance. FIG. 3 is a cross-sectional view schematically showing a lens sheet usable in Embodiment 1. As shown in FIG. 3, the lens sheet 84 is composed of recessed and projecting portions 84a and a base portion 84b. The unit structure of the recessed and projecting portions 84a is a projection structure that tapers to the tip. When the lens sheet 84 is viewed as a whole, the surface thereof is made of multiple folds parallel to one another. Accordingly, when the lens sheet 84 is viewed in a plan view, the surface has a vertical stripe pattern including multiple straight lines.

Examples of the lens sheet 84 include BEF lenses (produced by Sumitomo 3M Limited.). Among the BEF lenses, BEFII has a height (including recessed and projecting portions and a base portion) of 155 μm and a height of the base portion of 125 μm. The distance between the tips of adjacent projections is 50 μm, that is, the pitch width of the lens sheets upon use of the BEFII is 50 μm. The angle formed between the slanted surfaces of adjacent projections is 90°.

The diffusion sheet 85 is an optical sheet that diffuses the outgoing light emitted from the lens sheet 84 to widen a viewing angle of display. Examples of the diffusion sheet 85 include a sheet diffusing light using surface roughness thereof due to a sheet material, and a sheet on which beads are dispersed in a binder. Examples of a material of the diffusion sheet 85 include PET, PC (polycarbonate), and PMMA (polymethyl methacryl acid).

The optical sheet used herein includes the reflective sheet 81, the lens sheet 84, and the diffusion sheet 85. In Embodiment 1, multiple folds parallel to one another are configured on the surface of the lens sheet 84, and therefore at least the lens sheet 84 corresponds to the optical sheet of the present invention.

FIGS. 4-1 and 4-2 are each a plan view schematically showing a sub pixel unit in a display region of the liquid crystal display device of Embodiment 1. FIG. 4-1 is a view when no voltage is applied, and FIG. 4-2 is a view when a voltage is applied. An outer frame shown in FIG. 4-1 and FIG. 4-2 is black based on a BM. A fence portion that extends longitudinally from the top and bottom of the outer frame is black based on a portion (line) 91 of the comb teeth of the comb-shaped electrode. In addition, an interval (space) 92 having a constant width is formed between the lines 91.

As shown in FIG. 4-1, liquid crystal molecules are perpendicularly aligned when no voltage is applied. Therefore, a polarizing plate blocks all light, and it goes pitch-dark. As shown in FIG. 4-2, when a voltage is applied, the alignment of liquid crystal molecules changes, and the region of the space 92 is white displayed.

As shown in FIG. 4-2, a black display part and a white display part are formed in a stripe pattern. However, the size of sub pixels is on the order of microns. Therefore, when a display screen is viewed, a stripe pattern only based on this is not readily visually observed. However, when the stripe pattern based on the regularity of the structure in the optical sheet of the above-mentioned backlight unit and the stripe pattern based on the regularity of the comb teeth of the comb-shaped electrode causes light interference, significant interference fringes (moiré) may appear on a display screen.

FIG. 5 is a first conceptual view showing generation of moiré. In FIG. 5, rising diagonal lines from bottom left to top right are lines 101 showing projections of the lens sheet, and lines with multiple rectangles arranged in a lattice form are lines 102 showing a BM. Falling diagonal lines 103 from top left to bottom right which run through the intersection between the lines 101 showing the projections of the lens sheet and the lines 102 showing the BM are lines of interference fringes appearing as moiré. In FIG. 5, the pitch width of the lens sheet is 50 μm, and the pitch width of the BM is 300 μm.

FIG. 6 is a second conceptual view showing generation of moiré. In FIG. 5, the direction of the lines of the projections of the lens sheet differs from that of the lines of the BM. In contrast, the directions of these lines are the same in FIG. 6. Accordingly, moiré based on the lines 101 of the projections of the lens sheet and the lines 102 of BM tends to be generated. In addition, since the pitch P1 of the comb teeth of comb-shaped electrodes is an integral multiple of the pitch P2 of the lens sheet, moiré based on the lines 104 of the comb teeth of the comb-shaped electrodes and the lines 101 of the projections of the lens sheet is further generated.

Hereinafter, the cases where moiré caused by light interference occurs and does not occur will be described specifically by way of examples and comparative examples.

### EXAMPLE 1

FIG. 7 is a plan view schematically showing a sub pixel unit in a display region of a liquid crystal display device of Example 1. First, a pair of glass substrates was prepared, and an ITO film was formed on the entire surface of one of the pair of glass substrates. Then, a pair of comb-shaped electrodes made of ITO was prepared by photolithography so that the width (electrode width) L of a line 91 of each of the comb teeth is 2.5 μm and the width (electrode space) S of a space 92 between the adjacent two comb teeth is 8 μm, that is, a pitch width P is 10.5 μm.

Then, an alignment film coating material JALS-204 (5 wt %, γ-butyrolactone solution) produced by JSR was coated on the comb-shaped electrode and the glass substrate by spin coating, and baked at 200° C. for 2 hours.

Next, a BM having a width of 10 μm, a length of 100 μm in a transverse direction, and a length of 300 μm in a longitudinal direction was formed on another glass substrate, an OC (overcoat) layer was formed by spin coating on the BM and the glass substrate, and then baking was performed at 200° C. for one hour.

Subsequently, a liquid material of a columnar spacer was applied to an OC layer by spin coating, and thereafter a columnar spacer having a height of 3.4 μm was produced by photolithography. Further, the same alignment film coating material JALS-204 was applied to the OC layer by spin coating (5 wt %, γ-butyrolactone solution), and then baked at 200° C. for two hours. The thickness of each of the alignment films thus formed on both glass substrates was about 1000 Å.

Next, a seal resin produced by Mitsui Chemicals, Inc. (STRUCTBOND XN-21S) was printed on a pair of substrates thus produced, and these was bonded to each other, and baked at 135° C. for one hour to produce a liquid crystal cell.

Thereafter, a positive type liquid crystal material produced by Merck (Δε=18, Δn=0.1) was sealed between a pair of the substrates by vacuum injection, and a polarizing plate was attached to the opposite sides of the liquid crystal layer sides of the pair of the substrates, and thereby the liquid crystal display element was completed.

Then, the thus-produced liquid crystal display element was put on a backlight unit that equips an LED as a light source, the various angles of a line of each projection of a BEF lens of the backlight unit produced by Sumitomo 3M Limited was selected in an incident light direction of LED light (extension of LED) in the range of θ=from 0 to ±15°, and the state of moiré when a voltage is applied was observed. The smaller the value of θ is, the closer to each other the line direction of the lens sheet and the line direction of the BM and the comb teeth of the comb-shaped electrodes are, and the more likely moiré is to occur. The larger the value of θ is, the less likely moiré is to occur, and the worse the light use efficiency is. Thus, the luminance tends to be deteriorated.

### EXAMPLE 2

FIG. 8 is a plan view schematically showing a sub pixel unit in a display region of a liquid crystal display device of Example 2. The liquid crystal display device of Example 2 having the same configuration as in Example 1 was produced, except that the width (electrode width) L of the line 91 of the comb teeth was 2.5 μm, and the width (distance between electrodes) S of the space 92 between the comb teeth was 5 μm, that is, the pitch width P was 7.5 μm.

### EXAMPLE 3

FIG. 9 is a plan view schematically showing a sub pixel unit in a display region of a liquid crystal display device of Example 3. The liquid crystal display device of Example 3 having the same configuration as in Example 1 was produced, except that the width (electrode width) L of the line 91 of the comb teeth was 2.5 μm, the width (distance between electrodes) S of the space 92 between the comb teeth was 7 μm, that is, the pitch width P was 9.5 μm, and the comb teeth was extended obliquely at an angle of 45° in two directions with respect to one side of a sub pixel, that is, the entire shape of the pair of comb-shaped electrodes was a V shape. A source line was produced along the outer shape of the comb-shaped electrodes to extend obliquely at an angle of 45° in two directions with respect to one side of a sub pixel.

### COMPARATIVE EXAMPLE 1

FIG. 10 is a plan view schematically showing a sub pixel unit in a display region of a liquid crystal display device of Comparative Example 1. The liquid crystal display device of Comparative Example 1 having the same configuration as in Example 1 was produced, except that after an ITO film was formed by sputtering, patterning was not performed by photolithography. As a result, the liquid crystal display device of Comparative Example 1 does not have an electrode portion having a tooth shape in a sub pixel and has substantially the same display mode as a VA mode. Therefore, the line pitch does not change even when a voltage is applied, and a pitch width of 100 μm based on the line 93 of the BM results from light interference. The mode of Comparative Example 1 was usually a VA mode, and therefore evaluation was made with a negative type liquid crystal material (Δε=3).

### COMPARATIVE EXAMPLE 2

FIG. 11 is a plan view schematically showing a sub pixel unit in a display region of a liquid crystal display device of Comparative Example 2. The liquid crystal display device of Comparative Example 1 having the same configuration as in Example 1 was produced, except that the width (electrode width) L of the line 91 of the comb teeth was 2.5 μm, and the width (distance between electrodes) S of the space 92 between the comb teeth was 10 μm, that is, the pitch width P was 12.5 μm.

FIGS. 12 to 16 are each a graph showing the relationship between a pitch (mm) of moiré stripes generated upon display with the liquid crystal display device and a rotation angle of a BEF lens (lens sheet) (°). FIG. 12, FIG. 13, FIG. 14, FIG. 15, and FIG. 16 correspond to Example 1, Example 2, Example 3, Comparative Example 1, and Comparative Example 2, respectively.

As shown in FIG. 15, in the liquid crystal display device of Comparative Example 1, moiré stripes were not reduced until the angle of rotation of the BEF lens reached ±14°. As shown in FIG. 16, in the liquid crystal display device of Comparative Example 2, moiré stripes were not reduced until the angle of rotation of the BEF lens reached ±3.7°.

In contrast, thin slight moiré stripes were observed until the angle of rotation of the BEF lens reached ±0.5° in the liquid crystal display device of Example 1, good display without any moiré visually observed on any conditions of Examples 2 and 3 was obtained.

In the liquid crystal display devices of Examples 1 to 3 and Comparative Examples 1 and 2, Table 1 summarizes the evaluation results of the level of moiré in the display screen.

TABLE 1

| | | | | | Comparative | Comparative |
|---|---|---|---|---|---|---|
| Driving voltage | θ | Example 1 | Example 2 | Example 3 | Example 1 | Example 2 |
| When no voltage | ±15° | ◯ | ◯ | ◯ | ◯ | ◯ |
| is applied | 0° | ◯ | ◯ | ◯ | ◯ | ◯ |
| When a voltage is | ±15° | ◯ | ◯ | ◯ | ◯ | ◯ |
| applied | 0° | ◯ | ◯ | ◯ | X | Δ |

| | | | | | |
|---|---|---|---|---|---|
| Pitch (line + space)[μm] | 10.5 | 1.5 | 9.5 | 10D | 12.5 |
| Angle θ at which moire is | ±0.5° | ±0° | ±0° | ±14° | ±3.7° |
| reduced | | | | | |
| Color | Slightly purple | Slightly yellow | Slightly yellow | Not changed | Bluish purple |
| Comprehensive evaluation | ◯ | ◯ | ◯ | X | X |

Regarding the evaluation of OFF-time and ON-time operation for the driving voltage in Table 1, “◯” shows good display with no moiré, “Δ” shows not good display with slight moiré, and “×” shows poor display with remarkable moiré.

Regarding the comprehensive evaluation in Table 1, “◯” shows a liquid crystal display device which may be used as a product, and “×” shows a liquid crystal display device which may not be used as a product.

The ratio of the pitch width (line width+space width) of the comb teeth of a pair of comb-shaped electrodes to the pitch width of the folds of the BEF lens was 100/50 (twice) in Comparative Example 1, and was 50/12.5 (four times) in Comparative Example 2. Therefore, the ratio was confirmed to be an integral multiple in Comparative Examples 1 and 2.

Meanwhile, the ratio of the pitch width (line width+space width) of the comb teeth of a pair of comb-shaped electrodes to the pitch width of the folds of a BEF lens is 50/10.5 (4.7619 . . . times) in Example 1, 50/7.5 (6.6666 . . . times) in Example 2, and 50/9.5 (5.2631 . . . times) in Example 3. Therefore, in each of these examples, the ratio was confirmed to be different from an integral multiple.

Next, the relationship between the pitch width of the comb teeth of a pair of comb-shaped electrodes and the transmittance was studied. First, as samples for comparing the pitch widths of comb teeth, five samples whose pitch widths were 5.0 μm, 7.5 μm, 9.5 μm, 10.5 μm, and 12.5 μm and which had the same configurations as those of Examples 1 to 3 were used. Table 2 shows the results of aperture ratios and transmittances of these five samples.

TABLE 2

| | Aperture | Substantial | | Substantial |
|---|---|---|---|---|
| Pitch width | ratio | aperture ratio | Transmittance | transmittance |
| 5.0 μm | 50.0% | 40.0% | 4.2% | 3.4% |
| 7.5 μm | 67.5% | 54.0% | 5.7% | 4.5% |
| 9.5 μm | 75.0% | 60.0% | 6.3% | 5.0% |
| 10.5 μm | 77.5% | 62.0% | 6.5% | 5.2% |
| 12.5 μm | 60.0% | 64.0% | 6.7% | 5.4% |

Table 2 shows the aperture ratios and transmittances calculated by the comb teeth pitch. In fact, members such as BMs, lines, and TFTs block light to an aperture ratio portion, the aperture ratios and transmittances fall to substantially 80% relative to the actual aperture ratios and transmittances. In consideration of this respect, a good transmittance is obtained in the case of using a pair of comb-shaped electrodes having an aperture ratio of substantially 54.0% or higher, a transmittance of 4.5% or higher, and a pitch width of 7.5 μm or higher. The aperture ratios were calculated by removing a line portion from an aperture portion was used in each case of disposing these five samples having the pitch widths shown in Table 2 under assumption that light does not transmit the line and that the size of each pixel is 100×300 μm.

FIG. 17 is a graph showing the relationship between a pitch width of comb teeth of a pair of comb-shaped electrodes and an aperture ratio. As shown in FIG. 17, the larger the pitch width is, the larger the aperture ratio is.

Subsequently, color change of the moiré portion was examined by a general formula of transmission diffraction efficiency. Specifically, transmission efficiency of multiple diffraction pitches in each wavelength when a substrate surface was viewed from a front direction was calculated by the general formula of the diffraction efficiency upon transmission. Here, the examination is made such that red is 700 nm, green is 550 nm, and blue is 450 nm. The general formula of the transmission diffraction efficiency upon transmission is expressed by the following formula.

η=sin²(πΔnd/λ cos θ)

The parameters of the formula are as follows.
λ: incident wavelength
Δn: deviation of the average refractive index of incident polarization between voltage application and no voltage application
θ: angle formed by a glass substrate surface and a liquid crystal layer surface;
d: pitch of comb teeth
   The angle θ formed by the glass substrate surface and the liquid crystal layer surface was 0°.

The Δn was obtained by calculating the average refractive index of the incident polarization upon voltage application and the average refractive index of the incident polarization upon no voltage application and thereafter calculating the difference of these average refractive indices. Before and after voltage application, no change of the inclination of the liquid crystal molecules was observed above the comb tooth line, and therefore the average refractive index was 0 and did not change. Meanwhile, the inclination of liquid crystal molecules above a space changes. Therefore, polarized light enters a liquid-crystal-layer surface also from a direction at an angle of 45°, and the average refractive index changes from 0 and comes close to λ/2. The extraordinary index ne of the liquid crystal molecules used in examples and comparative examples was 1.578, and the ordinary index no was 1.477. Therefore, the average refractive index of the liquid crystal molecules was 1.5275, obtained by (ne+no)/2, when a voltage was applied. The average refractive index of the liquid crystal molecules was 1.477 obtained by no when no voltage was applied. Therefore, the Δn was 0.0505 obtained by subtracting the average refractive index upon no voltage application from the average refractive index upon voltage application.

Table 3 and FIG. 18 are respectively a table and a graph that summarize transmission efficiency of multiple diffraction pitches in each wavelength calculated by the general formula of the diffraction efficiency upon transmission when Δn=0.0505.

TABLE 3

| | Pitch width of a pair of comb-shaped electrode | | | |
|---|---|---|---|---|
| | (pitch diffraction) | | | |
| Wavelength | 6 μm | 8 μm | 10 μm | 12 μm |
| 400 nm | 73% | 10% | 15% | 79% |
| 410 nm | 77% | 14% | 9% | 70% |
| 420 nm | 81% | 19% | 5% | 61% |
| 430 nm | 85% | 24% | 2% | 52% |
| 440 nm | 88% | 29% | 1% | 43% |
| 450 nm | 90% | 35% | 0% | 35% |
| 460 nm | 93% | 40% | 0% | 27% |
| 470 nm | 95% | 45% | 2% | 20% |
| 480 nm | 96% | 50% | 4% | 15% |
| 490 nm | 97% | 55% | 6% | 10% |
| 500 nm | 98% | 59% | 10% | 6% |
| 510 nm | 99% | 64% | 13% | 3% |
| 520 nm | 100% | 68% | 17% | 1% |
| 530 nm | 100% | 72% | 21% | 0% |
| 540 nm | 100% | 75% | 25% | 0% |
| 550 nm | 100% | 78% | 29% | 0% |
| 560 nm | 100% | 81% | 33% | 1% |
| 570 nm | 99% | 84% | 38% | 3% |
| 580 nm | 99% | 86% | 42% | 5% |
| 590 nm | 98% | 88% | 46% | 7% |
| 600 nm | 98% | 90% | 50% | 10% |
| 610 nm | 97% | 92% | 54% | 12% |
| 620 nm | 96% | 94% | 58% | 16% |
| 630 nm | 95% | 95% | 61% | 19% |
| 640 nm | 94% | 96% | 65% | 22% |
| 650 nm | 93% | 97% | 68% | 26% |
| 660 nm | 92% | 98% | 71% | 29% |
| 670 nm | 91% | 99% | 74% | 33% |
| 680 nm | 90% | 99% | 76% | 36% |
| 690 nm | 89% | 100% | 79% | 40% |
| 700 nm | 88% | 100% | 81% | 43% |
| 710 nm | 87% | 100% | 83% | 47% |
| 720 nm | 85% | 100% | 85% | 50% |
| 730 nm | 84% | 100% | 87% | 53% |

As shown in FIG. 18, a bottom wavelength tended to shift from a short wavelength side to a long wavelength side as the diffraction pitch enlarges. As a result, moiré interference with different colors in a visible light wavelength region was generated. Specifically, green coloring occurred at a diffraction pitch of 6 μm, orange coloring occurred at a diffraction pitch of 8 μm, magenta coloring occurred at a diffraction pitch of 10 μm, and purple coloring occurred at a diffraction pitch of 12 μm.

A closer examination was performed with a simulator based on the experimental results. The examination showed that green coloring occurred at a diffraction pitch of 6 μm, yellowish green coloring occurred at a diffraction pitch of 7 μm, yellowish red coloring occurred at a diffraction pitch of 8 μm, red coloring occurred at a diffraction pitch of 9 μm, reddish purple coloring occurred at a diffraction pitch of 10 μm, purple coloring occurred at a diffraction pitch of 11 μm, and bluish purple coloring occurred at a diffraction pitch of 12 μm.

A liquid crystal display panel was produced such that the pitch of a pair of comb-shaped electrodes have the above diffraction pitch, and the color change was visually examined. As a result, slightly yellow coloring was visually observed at a pitch of the pair of comb-shaped electrodes of 7.5 μm, slightly yellow coloring was visually observed at a pitch of the pair of comb-shaped electrodes of 9.5 μm, slightly purple coloring was visually observed at a pitch of the pair of comb-shaped electrodes of 10.5 μm, and blue purple coloring was visually observed at a pitch of the pair of comb-shaped electrodes of 12.5 μm. The results were in agreement with the tendency of the color change with a simulator and supported the spectrum in simulation. The visual observation proved that the reduction in the level of moiré involved less color change of moiré.

### Embodiment 2

FIG. 19 is a cross-sectional view schematically showing a configuration of a liquid crystal display device in accordance with Embodiment 2. As shown in FIG. 19, the liquid crystal display device of Embodiment 5 is provided with a liquid crystal display panel including a liquid crystal layer 13 and a pair of substrates 11 and 12 sandwiching the liquid crystal layer 13. One of the pair of substrates is a TFT substrate 11, and the other is a counter substrate 12.

The liquid crystal display device of Embodiment 2 differs from that of Embodiment 1 in the following points. The present liquid crystal display device has a counter electrode 62 disposed on a counter-substrate-12 side. The counter electrode 62, a dielectric layer (insulating layer) 63, and a vertical alignment film 52 are stacked in this order on the liquid-crystal-layer-13-side main surface of a glass substrate included in the counter substrate 12. A color filter and/or a black matrix (BM) may be disposed between the counter electrode 62 and the glass substrate 32.

The counter electrode 62 is formed of a transparent conductive film such as an ITO film and an IZO film. The seamless counter electrode 62 and the seamless dielectric layer 63 are each formed at least over the entire display region. Predetermined electric potential is applied to the counter electrode 62. The electric potential is common between each pixel and each sub pixel.

The dielectric layer 63 is formed of a transparent insulating material. Specific examples of the insulating material include inorganic insulating films such as a silicon nitride film, and organic insulating films such as an acrylic resin film.

Meanwhile, similarly to Embodiment 1, a pair of comb-shaped electrodes including a pixel electrode 21 and a counter electrode 22, and a vertical alignment film 51 are disposed on the liquid-crystal-layer-13-side main surface of the glass substrate 31 included in the TFT substrate 11. Polarizers 71 and 72 are arranged on the outer main surfaces of the two glass substrates 31 and 32, respectively.

Different voltages are applied between the pixel electrode 21 and the counter electrode 22, and between the pixel electrode 21 and the counter electrode 62, during non-black display. The counter electrode 22 and the counter electrode 62 may be grounded. The same level of a voltage with the same polarity may be applied to the counter electrode 22 and the counter electrode 62. Different levels of voltages with different polarities may be applied to the counter electrode 22 and the counter electrode 62.

According to the liquid crystal display device of Embodiment 2, similarly to Embodiment 1, generation of moiré when a voltage is applied can be suppressed. Further, response speed can be increased by forming the counter electrode 62.

FIG. 20 is a plan view schematically showing the configuration of the liquid crystal display device in accordance with Embodiment 2. The features of the configuration shown in FIG. 20 may be applied to those in Embodiment 1. A pixel may comprise a plurality of sub pixels, and in this case, the following configuration shows a sub pixel. The 3 o'clock direction, 12 o'clock direction, 9 o'clock direction, and 6 o'clock direction, when the liquid crystal display device is viewed from the front, are the 0° direction (azimuth), 90° direction (azimuth), 180° direction (azimuth) and 270° direction (azimuth), respectively, and the direction passing through the 3 o'clock and 9 o'clock is the left-right direction, and the direction passing through 12 o'clock and 6 o'clock is the up-down direction.

On the liquid-crystal-layer-13-side main surface of the glass substrate 31, signal lines 23, scanning lines 25, a common line 34, a thin film transistor (TFT) 27 that is a switching element (active element) and is formed in each sub pixel, a pixel electrode 21 separately formed in each sub pixel, and a counter electrode 22 connected with the common line 34 formed to be commonly used among a plurality of pixels (for example, all sub pixels) are disposed.

The scanning lines 25, and the common line 34, and the counter electrode 22 are formed on the glass substrate 31. A gate insulating film (not shown) is formed on the scanning lines 25, the common line 34, and the counter electrode 22. The signal lines 23 and the pixel electrode 21 are formed on the gate insulating film, and a vertical alignment film 51 is formed on the signal lines 23 and the pixel electrode 21.

The common line 34, the counter electrode 22, and the pixel electrode 21 are patterned by photolithography using the same film in the same step, and may be arranged on the same layer (the same insulating film).

The signal lines 23 are linearly arranged in parallel with each other, and extend in an up-down direction between the adjacent two sub pixels. The scanning lines 25 are linearly arranged in parallel with each other, and extend in a horizontal direction between the adjacent two sub pixels. The signal lines 23 are perpendicular to the scanning lines 25. The region partitioned by the signal lines 23 and the scanning lines 25 is approximately one sub pixel. The scanning lines 25 function as a gate of the TFT 27 in a display region.

The TFT 27 is formed near the intersection portion of each of the signal lines 23 and each of the scanning lines 25, and includes a semiconductor layer 28 formed in an island shape on the scanning line 25. The TFT 27 has a source electrode 24 which functions as a source, and a drain electrode 26 which functions as a drain. The source electrode 24 connects the TFT 27 and the signal line 23, and the drain electrode 26 connects the TFT 27 and a pixel electrode 21. The source electrode 24 and the signal lines 23 are patterned in the same film, and are connected with each other. The drain electrode 26 and the pixel electrode 21 are patterned in the same film, and are connected with each other.

A signal voltage (picture signal) is applied to the pixel electrode 21 from the signal lines 23 at predetermined timing during on-state of the TFT 27. Meanwhile, a predetermined electric potential (common voltage) is applied to the common line 34 and the counter electrode 22. The electric potential is common between each pixel.

The pixel electrode 21 has a comb-teeth shape in plan view. The pixel electrode 21 has a linear trunk portion (pixel trunk portion 45) and a plurality of linear comb-tooth portions (pixel comb-tooth portions 46). The pixel trunk portion 45 is formed along a short side (lower side) of a pixel. The pixel comb-tooth portions 46 are connected with the pixel trunk portion 45. Each of the pixel comb-tooth portions 46 extends from the pixel trunk portion 45 toward a short side (upper side) facing the pixel trunk portion 45, that is, in the about 90° direction.

The counter electrode 22 has a comb-teeth shape in plan view, and has a plurality of linear comb-tooth portions (counter comb-tooth portions 35). The counter comb-tooth portions 35 and the common line 34 are patterned in the same film, and are connected with each other. That is, the common line 34 is also a trunk portion (counter trunk portion) of the counter electrode 22 that connects the plurality of counter comb-tooth portions 35 with each other. The common line 34 is formed in a linear shape and parallel with the scanning lines 25, and extends in a horizontal direction between the adjacent two sub pixels. The counter comb-tooth portions 35 extend from the common line 34 toward a lower side facing the common line 34, that is, in the about 270° direction.

Thus, the pixel electrode 21 and the counter electrode 22 are arranged to face each other so that the comb teeth of the pixel electrode 21 and the counter electrode 22 (pixel comb-tooth portions 46, counter comb-tooth portions 35) are disposed alternately and spaced apart from each other. That is, the pixel comb-tooth portions 46 and the counter comb-tooth portions 35 are arranged parallel to each other, and are spaced apart from each other and alternately arranged.

According to one example shown in FIG. 20, two domains including the respective liquid crystal molecules with opposite inclinations are formed in one sub pixel. The number of the domains is not particularly limited. In order to achieve excellent visual-angle characteristics, four domains may be formed in one sub pixel.

According to one example shown in FIG. 20, one sub pixel includes two or more regions different in electrode space. Specifically, the regions include a region with a relatively small electrode space (a region with a space of Sn) and a region with a relatively large electrode space (a region with a space of Sw). Thereby, a threshold value of VT characteristics differs between such regions. Particularly, degree of an inclination of the VT characteristics of the entire sub pixels at low gradation can become small. As a result, occurrence of white floating can be suppressed and viewing angle characteristics can be improved. The white floating refers to a phenomenon where display that ought to appear dark appears whitish when an observation direction is changed from a front direction to an oblique direction during relatively dark display at low gradation.

The present application claims priority to Patent Application No. 2009-130187 filed in Japan on May 29, 2009, and Patent Application No. 2010-005108 filed in Japan on Jan. 13, 2010 under the Paris Convention and provisions of national law in a designated State, the entire contents of which are hereby incorporated by reference.

### EXPLANATION OF NUMERALS AND SYMBOLS

1: Liquid crystal display panel
2: Backlight unit
11: TFT substrate
12: Counter substrate
13: Liquid crystal layer
14: A pair of comb-shaped electrodes
21: Pixel electrode
22: Counter electrode
23: Signal line
24: Source electrode
25: Scanning line (gate line)
26: Drain electrode
27: TFT
28: Semiconductor layer
31, 32: Glass substrate
34: Common line (counter trunk portion)
35: Counter comb-tooth portion
41: Color filter
41R: Red color filter
41G: Green color filter
41B: Blue color filter
42: Black matrix (BM)
45: Pixel trunk portion
46: Pixel comb-tooth portion
51, 52: Vertical alignment film
61: Liquid crystal molecule
62: Counter electrode
63: Dielectric layer
71, 72: Polarizer
81: Reflective Sheet
82: Light source
83: Light guide plate
84: Lens sheet
84a: Recessed and projecting portions
84b: Base portion
85: Diffusion sheet
91, 104: Comb tooth line
92: Space between adjacent two comb teeth
93, 102: Line of BM
101: line of projecting portions of lens sheet
103: Moiré

1. A liquid crystal display device, comprising:
a liquid crystal display panel including a liquid crystal layer and a pair of substrates sandwiching the liquid crystal layer; and
a backlight unit disposed on a back side of the liquid crystal display panel,
one of the pair of substrates including a pair of comb-shaped electrodes each having comb teeth, the comb teeth of one of the pair of comb-shaped electrodes and the comb teeth of the other of the pair of comb-shaped electrodes being disposed alternately and spaced apart from each other,
the liquid crystal layer containing liquid crystal molecules with positive dielectric an isotropy,
the liquid crystal molecules being aligned in a direction perpendicular to a surface of the one of the pair of substrates when no voltage is applied,
the backlight unit having an optical sheet with multiple folds parallel to one another on a surface,
the pitch width of the pair of comb-shaped electrodes being different from an integral multiple of the pitch width of the folds of the optical sheet.

2. The liquid crystal display device according to claim 1,
wherein comb tooth lines of the comb-shaped electrodes are each parallel to the folds of the optical sheet.

3. The liquid crystal display device according to claim 1,
wherein the pitch width of the comb teeth of the pair of comb-shaped electrodes is 9.5 μm or less.

4. The liquid crystal display device according to claim 1,
wherein the pitch width of the comb teeth of the pair of comb-shaped electrodes is 9.5 to 12.5 μm, and
the angle formed by a comb tooth line of the comb-shaped electrodes and a fold of the optical sheet is less than 3°.

5. The liquid crystal display device according to claim 1,
wherein the pitch width of the comb teeth of the pair of comb-shaped electrodes is 7.5 μm or higher.
